(19) United States
(12) Patent Application Publication
(10) Pub. No.: US 2024/0331396 A1
(43) Pub. Date: Oct. 3, 2024

(54) PAIRED-CAMERA ROAD SURFACE LEAK DETECTION

(71) Applicant: TORC Robotics, Inc., Blacksburg, VA (US)

(72) Inventor: John HUTCHINSON, Blacksburg, VA (US)

(73) Assignee: TORC Robotics, Inc., Blacksburg, VA (US)

(21) Appl. No.: 18/192,481

(22) Filed: Mar. 29, 2023

(51) Int. Cl. G06V 20/56; G06V 10/75

(52) U.S. Cl. CPC G06V 20/56; G06V 10/751

(57) ABSTRACT

Embodiments described herein systems and methods for detecting fluid leaks for an automated vehicle using image data. The automated vehicle includes a camera at or near the front of the chassis and a camera at or near the rear of the chassis. Each camera captures images of a road surface beneath vehicle as the vehicle passes a road surface. The cameras store images of the road surface into a log with timestamp or location stamp, by mapping the image to a location in the world. An algorithm de-warps the images to correct for lensing. Using the locations data, computer vision, and/or object recognition, a processor extracts features, overlays the images, and compares the features to identify differences between the images indicating dripping fluid. Multi-image comparisons avoid false positives. The processor may recognize that image features indicate fluid leaks based on characteristics of spots (e.g., color, location, size) or other features.

### TECHNICAL FIELD

This application generally relates to managing and detecting fluid leaks on vehicles using computer vision and image recognition.

### BACKGROUND

Vehicles have many fluids that can leak, causing accelerated wear, inefficient operation, failure of components, or unsafe operation. Drivers can monitor for these leaks by many methods, including looking for drips of fluids on the ground. The color of the fluid may help the driver identify the source of the leak. In automated vehicles, however, the driver has been removed, so other methods of monitoring for leaks are required. Some of this can be accomplished through vehicle checks performed at the start of a drive. But during long trips of an automated vehicle, leaks may occur that need to be detected, monitored, and flagged for investigation and repair, without human inspection.

### SUMMARY

Embodiments described herein systems and methods for detecting fluid leaks for an automated vehicle using image data. The automated vehicle includes a camera at or near the front of the chassis and a camera at or near the rear of the chassis. Each camera captures images of a road surface beneath vehicle as the vehicle passes a road surface. The cameras store images of the road surface into a log with timestamp or location stamp, by mapping the image to a location in the world. An image-processing engine may perform various normalization operations or corrections, such as an algorithm that dewarps the images to correct for lensing. Using the locations data, computer vision, and/or object recognition, a processor extracts features, overlays the images, and compares the features to identify differences between the images indicating dripping fluid. Multi-image comparisons avoid false positives. The processor may recognize that image features indicate fluid leaks based on characteristics of spots (e.g., color, location, size) or other features. As explained further below, embodiments may include any number of additional or alternative features as the above-mentioned features and still fall within the scope of this disclosure.

In an embodiment, a method comprises receiving, by a processor, a front image from a front camera of an automated vehicle and a rear image from a rear camera of the automated vehicle, the front camera is situated at a front portion of the automated vehicle and directed towards a road surface beneath the front portion of the automated vehicle, and the rear camera is situated at a rear portion of the automated vehicle and directed towards the road surface beneath the rear portion of the automated vehicle; determining, by the processor, one or more front image features from the front image, and one or more rear image features from the rear image; determining, by the processor, one or more differential image features based upon comparing the one or more front image features against the one or more rear image features from the rear image; and identifying, by the processor, a fluid leak of the automated vehicle using the one or more differential image features by applying an object recognition engine on the one or more differential image features.

In another embodiment, a method comprises generating, by a processor, a front overlay image comprising image data of a plurality of front images and a second overlay image comprising image data of a plurality of back images, each front image received from a front camera fixed to a front portion of an automated vehicle, and each rear image received from a rear camera fixed to a rear portion of the automated vehicle; determining, by the processor, one or more front image features from the front overlay image, and one or more rear image features from the rear overlay image; determining, by the processor, one or more differential image features based upon comparing the one or more front image features against the one or more rear image features from the rear image; and identifying, by the processor, a fluid leak of the automated vehicle using the one or more differential image features by applying an object recognition engine on the one or more differential image features.

In yet another embodiment, system comprises a non-transitory computer-readable medium comprising instructions that when executed by at least one processor are configured to: receive a front image from a front camera of an automated vehicle and a rear image from a rear camera of the automated vehicle, the front camera is situated at a front portion of the automated vehicle and directed towards a road surface beneath the front portion of the automated vehicle, and the rear camera is situated at a rear portion of the automated vehicle and directed towards the road surface beneath the rear portion of the automated vehicle; determine one or more front image features from the front image, and one or more rear image features from the rear image; determine one or more differential image features based upon comparing the one or more front image features against the one or more rear image features from the rear image; and identify a fluid leak of the automated vehicle using the one or more differential image features by applying an object recognition engine on the one or more differential image features.

In another embodiment, a system comprises a non-transitory computer-readable medium comprising instructions that when executed by at least one processor are configured to: generate a front overlay image comprising image data of a plurality of front images and a second overlay image comprising image data of a plurality of back images, each front image received from a front camera fixed to a front portion of an automated vehicle, and each rear image received from a rear camera fixed to a rear portion of the automated vehicle; determine one or more front image features from the front overlay image, and one or more rear image features from the rear overlay image; determine one or more differential image features based upon comparing the one or more front image features against the one or more rear image features from the rear image; and identify a fluid leak of the automated vehicle using the one or more differential image features by applying an object recognition engine on the one or more differential image features.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views. The accompanying drawings, which are incorporated in and constitute a part of this specification, illustrate various exemplary embodiments and together with the description, serve to explain the principles of the disclosed embodiments.

FIG. 1A illustrates an automated vehicle having hardware and software components for detecting leaking fluid using image data, according to an embodiment.

FIG. 1B is a block diagram showing components of an image processing subsystem of the truck, according to the embodiment of FIG. 1A.

FIG. 2A is a frontend image of a road generated by a front camera of an automated vehicle, according to an embodiment.

FIG. 2B is a backend image of the road generated by a back camera of the automated vehicle, according to the embodiment.

FIG. 3 is a flowchart showing operational steps of a method for detecting leaking fluid based on images captured at a front and rear of an automated vehicle, according to an embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

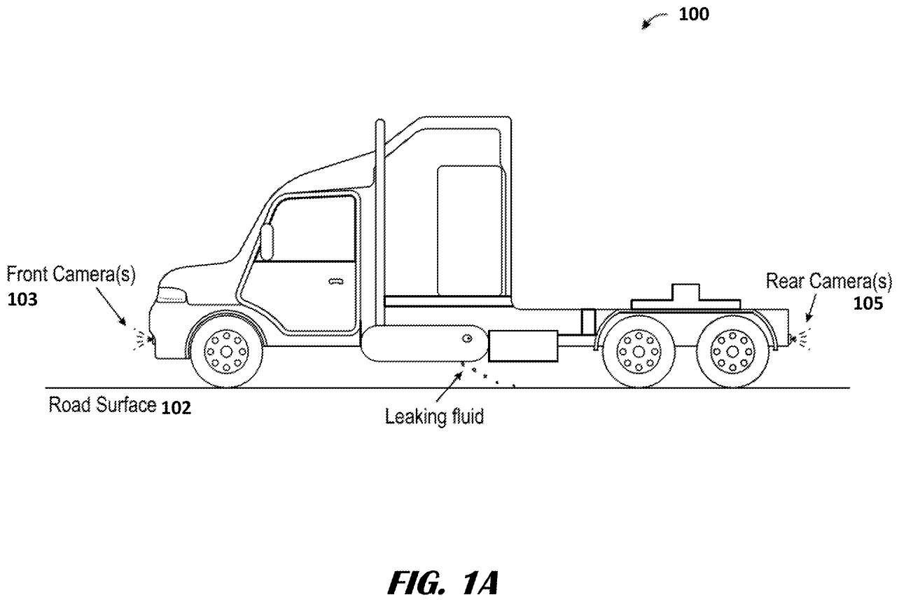

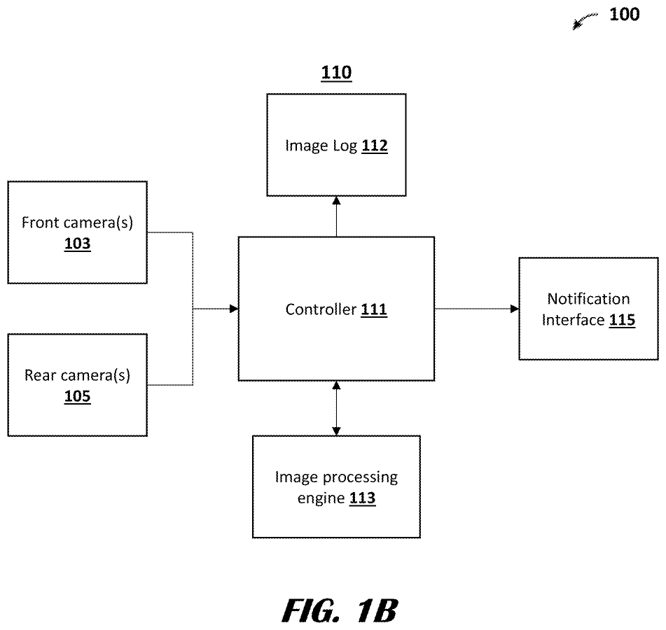

FIG. 1A illustrates an automated vehicle (shown as a truck 100) having hardware and software components for detecting leaking fluid using image data, according to an embodiment. FIG. 1B is a block diagram showing components of an image processing subsystem 110 of the truck 100, according to the embodiment of FIG. 1A.

The truck 100 includes one or more front cameras 103 situated near the frontend of the chassis, and one or more rear cameras 105 situated near the backend of the chassis. The cameras 103, 105 continuously or periodically capture imagery of the road surface 102 passing beneath the truck 100. The image processing subsystem 110 of the truck 100 includes hardware and software components that perform various image-processing operations, among other functions. The image processing subsystem 110 includes the cameras 103, 105; a controller 111 (or similar processor device) that manages operations of the image processing subsystem 110; an image log 112 hosted on a non-transitory machine-readable storage medium for storing images; an image-processing engine 113 comprising software for performing image analysis operations; and a notification interface 115 for generating messages indicating, for example, that the image-processing engine 113 detected a potential leak.

The non-transitory machine-readable storage medium hosts and manages data entries of the image log 112. The image log 112 contains image data generated by the cameras 103, 105 from images of the road surface 102 captured by the cameras 103, 105. The entries of the image log 112 contain the image data and additional information about the image, such as a timestamp. In some cases, portions of the image log 112 are stored in a storage medium situated at the truck 100 and coupled to the controller 111. In some cases, portions of the image log 112 are stored remotely in a storage medium of a remote computing device (not shown), accessible to the controller 111 (or other device of the truck 100) via one or more networks (not shown).

The front camera 103 or the back camera 105 captures imagery of the road surface 102 and translates the images into image data. The camera 103, 105 (or the controller 111) records the image data of the image of the road surface 101 with certain metadata. For instance, after the camera 103, 105 captures a particular image, the camera 103, 105 generates the image data for the image, the controller 111 receives the image and generates certain types of metadata, such as a timestamp or location stamp for the particular image, and then stores the image data into the image log 111.

The controller 111 comprises any processing device capable of performing the various processes described herein. The controller 111 is coupled to each camera 103, 105 for receiving and processing the image data from the cameras 103, 105. The controller 111 is coupled to, or in network communication with, the image log 112. The controller 111 may periodically or continuously fetch image data from the image data and feeds the image data to the image-processing engine 113. The controller 111 may execute (or instruct another computer device to execute) the processes of the image-processing engine 113.

The controller 111 continuously or periodically executes the image-processing engine 113 to detect leaks in the images captured by the cameras 103, 105, which may include the image data stored in the image log 112. The image-processing engine 113 comprises any number of layers of a machine-learning architecture. The layers of the image-processing engine 113 may define various software-based analysis engines that perform certain image pre-processing operations, and image analysis operations, among other potential operations. The pre-processing functions include, for example, correcting image flaws or normalizing the images, among others. As an example, the image pre-processing functions include an algorithm that dewarps the images to correct for lensing. As another example, the pre-processing functions include generating or referencing certain types of metadata, such as generating location data that maps the image to a location in the world. The pre-processing functions of the image-processing engine 113 or the controller 111 may generate a location stamp for the image, indicating the mapped location associated with eh image. The image analysis functions of the image-processing engine 113 include, for example, a computer vision engine and an object recognition engine. In some cases, the image processing engine 113 include layers defining a classifier or similar type of machine-learning model trained to predict a fluid leak or similar determinations. In operation, the controller 111 retrieves the image data from the image log 112 and applies the layers of the image-processing engine 113 on the image data.

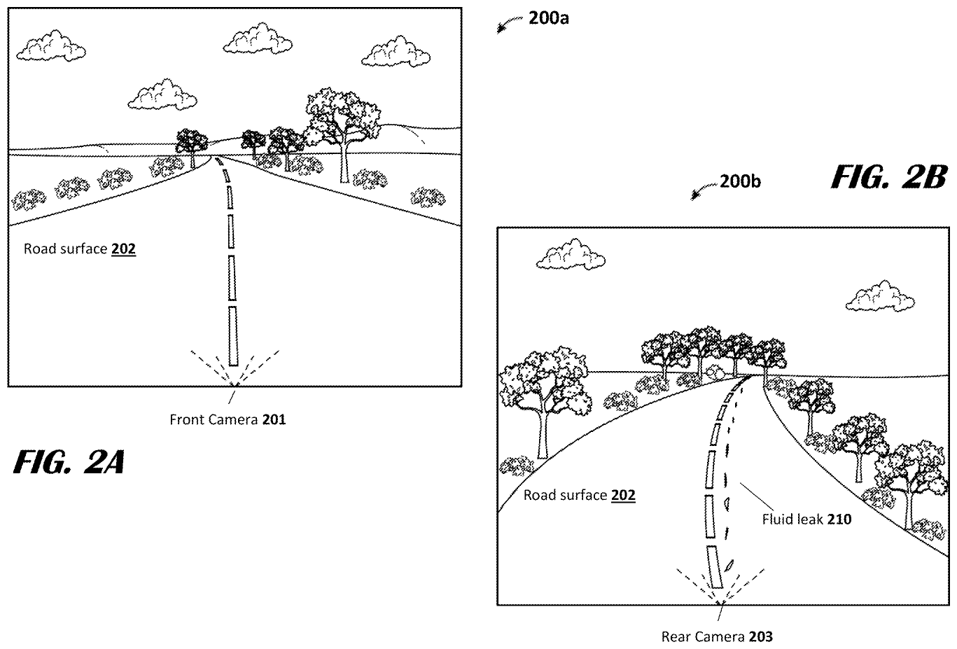

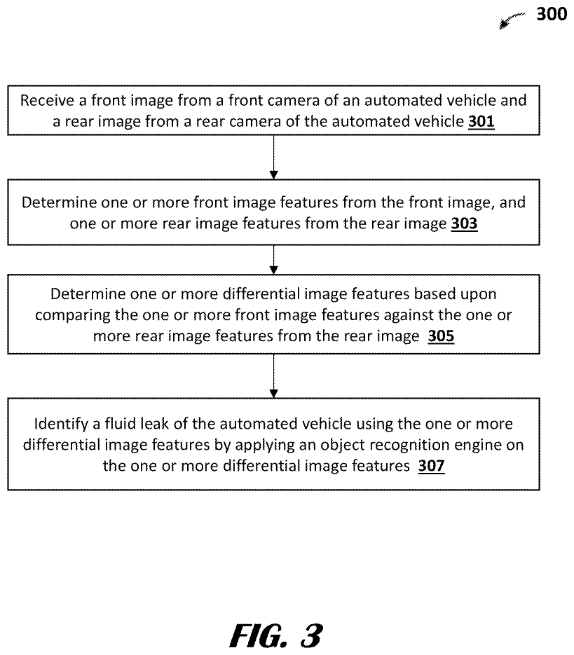

In some embodiments (such as the embodiment shown in FIGS. 2A-2B), the image-processing engine 113 is trained to recognize, for example, image features indicative of a fluid leak or a “clean” road surface 102 and identify differences or similarities amongst the features of the corresponding images. The controller 111 or image-processing engine 113 identifies a front image having a given stamp (e.g., timestamp, location stamp) and a corresponding rear image having a nearly identical stamp, though there may be a nominal difference. The image-processing engine 113 is trained to extract features from the image data and identify characteristics of parts of the road surface 102 that are distinct from other parts of the road surface 102, suggesting a fluid spot. Differences between the images, such as dark spots, may indicate that something dripped onto the road surface 102 as the truck 100 passed over a particular portion of the road surface 102. The image-processing engine 113 may compare the features extracted from the front image against the features extracted from the corresponding rear image. The image features may represent characteristics of the road surface 102, such as color, location, and size the spots, which the image-processing engine 113 is trained to reference to determine the likelihood of a fluid leak of the truck 100. The image-processing engine 113 may also be trained to use the features of the road surface 102 and characteristics of the predicted fluid spots to predict a source of a leak (e.g., green coolant spot versus dark oil; left side versus right side of the engine). Moreover, the image-processing engine 113 may be trained to predict the size of the leak using features such as the size, shape, and frequency of spots. For instance, the image-processing engine 113 is trained to identify a comparatively small and infrequently occurring spot indicates a small or slow leak, a comparatively large and continuous streak (present in multiple sequential images in both front and back images) indicates a larger and faster leak.

In some embodiments, the image-processing engine 113 is configured to perform a transformative overlay of multiple images to produce an overlay image as an amalgam of the multiple images for a given segment or distance of the road surface 102. The image-processing engine 113 is trained to recognize the image features indicative of a fluid leak or a “clean” road surface 102 and predict the likelihood of a fluid leak.

In some cases, the image-processing engine 113 generates a frontend overly image of only frontend images and a rear overlay image of only rear images. The image-processing engine 113 may extract and compare the image features from each overlay image to identify differences or similarities in the features. The image-processing engine 113 may predict the presence of the leak based upon the features identified in each overlay image and/or based upon the differences or similarities in the features. In this way, the image-processing engine 113 performs a comparison of the frontend imagery against backend imagery, but comparing overlay images beneficially mitigates against potential false positives.

In some cases, the image-processing engine 113 generates an integrated overlay image of frontend images and rear end images. The image-processing engine 113 may extract the image features from the integrated overlay image. The image-processing engine 113 may predict the presence of the leak based upon the features identified in the integrated overlay image. In this way, the image-processing engine 113 efficiently identifies potential leaks and mitigates against potential false positives.

The cameras 103, 105 may include any type of camera capable of generating digital image data sufficient to perform the features and functions described herein. The front camera 103 is fixed to any portion of the truck 100 offering an unobstructed view of the road surface 102 as the road surface 102 passes under the frontend of the truck 100. For instance, the front 103 may be attached to secure portion of the bumper and, in some cases, at the center of the truck 100. The rear camera 105 is fixed to any portion of the truck 100 offering an unobstructed view of the road surface 102 as the road surface 102 passes under the rear of the truck 100 or the rear of the cab. For instance, the rear camera 105 is mounted to the chassis directly behind the cab to avoid obstruction by a trailer or at the very rear of the truck 100. The rear camera 105, for example, may include a very wide-angle camera attached near the tail of the chassis.

In some embodiments, the cameras 103, 105 include infrared cameras (or similar thermal-imaging devices) that generate thermal images for the image data. The image-processing engine 113 may be trained to extract features based on thermal differences and predict leaks according to the thermal features. For example, a series of thermal images capture a series of images showing a streak of fluid. The image-processing engine 113 is trained to predict a fuel leak, where evaporating fuel is cooler than ambient air or road surface 102. Similarly, the image-processing engine 113 is trained to predict an oil leak, where hot oil leaking from the truck 100 is much hotter than ambient air or the road surface 102.

The notification interface 115 includes hardware and software components for communicating or presenting a notification to an administrator of the truck 100. In some implementations, the notification interface 115 includes a wireless communication interface that communicates notifications generated by the controller 111, to a computing device of the administrator via one or more networks. In some implementations, the notification interface 115 includes a user interface that displaying notifications generated by the controller 111. The notifications include various types of information about a predicted leak, such as the location, size, frequency, severity, or type of fluid of the predicted leak.

The controller 111 may execute one or more mitigation operations in response to detecting the leak, and in some cases, based on a severity or other characteristics of the leak. The mitigation operations may include, for example, generating a notification for the administrator, or instructing an automated driving system to perform a particular driving actions, such as pulling over, redirecting to a maintenance location, slowing down, or stopping. As an example, when the image-processing engine 113 detects a low-severity or non-critical leak, the controller 111 generates a notification for an administrator indicating the characteristics or other information about the predicted leak. The controller 111 may transmit the notification to a computing device of the administrator via the notification interface. As another example, when the image-processing engine 113 detects a severe or critical leak, the controller 111 generates a driving instruction rerouting the truck 100 to a maintenance location or stopping the truck 100 on the shoulder.

FIG. 2A is a frontend image 200a of a road generated by a front camera 201 of an automated vehicle, according to an embodiment. FIG. 2B is a backend image 200b of the road generated by a back camera 203 of the automated vehicle, according to the embodiment.

The front camera 201 is affixed to an automated vehicle near the front of the chassis and has a forward-facing field of view directed downwards to the road surface. The rear camera 203 is affixed to the automated vehicle near the rear of the chassis or just behind a cab. The rear camera 203 has a rear-facing field of view directed downwards to the road surface.

A controller (or other processing device) of the automated vehicle executes an image-processing engine for processing the images 200a, 200b and applying various machine-learning engines to detect a fluid leak by comparing the images 200a. 200b. A computer vision engine or object recognition engine identifies and compares features of the images 200a, 200b to identify similarities and differences. As an example, for the front image 200a, the image-processing engine detects characteristics and features of the road surface 202, including lane lines. For the rear image 200b, the image-processing engine detects characteristics and features of the road surface 202, such as the line lines and a streak of one or more drops that discolor the road surface 202. The image-processing engine identifies and determines, for example, a color of the drops, the frequency period of the drops, and a likely source-location of the drops (e.g., left side or right side of the truck).

The image-processing engine compares the image features or recognized objects identified in the front image 200a against the image features or recognized objects identified in the rear image 200b. The image-processing engine identifies, for example, identifies the dark spots in the rear image 200b parallel to the lane lines, and determines the dark spots are absent in the front image 200a. The image-processing engine is trained to predict that the dark spots of the rear image 200b are likely a fluid leak 210 using the identified characteristics of the dark spots, such as the comparative absence from the front image 200a, the color of the dark spots, and the frequency period of the dark spots.

FIG. 3 is a flowchart showing operational steps of a method 300 for detecting leaking fluid based on images captured at a front and rear of an automated vehicle, according to an embodiment.

In operation 301, a processor (or controller device) of the automated vehicle receives a front image from a front camera of the automated vehicle and a rear image from a rear camera of the automated vehicle. The front camera is situated at a front portion of the automated vehicle (e.g., at the front bumper or front of the chassis) and directed towards a road surface beneath the front portion of the automated vehicle. The rear camera is situated at a rear portion of the automated vehicle (e.g., at the chassis behind a cab, at the end of the chassis) and directed towards the road surface beneath the rear portion of the automated vehicle.

In operation 303, the processor determines one or more front image features from the front image, and one or more rear image features from the rear image. In operation 305, the processor determines one or more differential image features based upon comparing the one or more front image features against the one or more rear image features from the rear image.

In operation 307, the processor identifies a fluid leak of the automated vehicle using the one or more differential image features by applying an object recognition engine on the one or more differential image features. In response to identifying the fluid leak, the processor generates one or more types of notifications indicating that the fluid leak was predicted and various types of information about the fluid leak.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
receiving, by a processor, a front image from a front camera of an automated vehicle and a rear image from a rear camera of the automated vehicle, the front camera is situated at a front portion of the automated vehicle and directed towards a road surface beneath the front portion of the automated vehicle, and the rear camera is situated at a rear portion of the automated vehicle and directed towards the road surface beneath the rear portion of the automated vehicle;
determining, by the processor, one or more front image features from the front image, and one or more rear image features from the rear image;
determining, by the processor, one or more differential image features based upon comparing the one or more front image features against the one or more rear image features from the rear image; and
identifying, by the processor, a fluid leak of the automated vehicle using the one or more differential image features by applying an object recognition engine on the one or more differential image features.

2. The method according to claim 1, further comprising:
generating, by the processor, a first metadata stamp for the front image and a corresponding second metadata stamp for the rear image; and
storing, by the processor into an image log, the front image, the first metadata stamp, second metadata stamp, and the rear image.

3. The method according to claim 2, further comprising selecting, by the processor, the rear image having the second metadata stamp according to the corresponding first metadata stamp of the front image associated with the rear image.

4. The method according to claim 2, wherein the first metadata stamp and the second metadata stamp includes at least one of a timestamp or a location stamp.

5. The method according to claim 1, further comprising generating, by the processor, a notification indicating the fluid leak in response to identifying the fluid leak.

6. A method comprising:
generating, by a processor, a front overlay image comprising image data of a plurality of front images and a second overlay image comprising image data of a plurality of back images, each front image received from a front camera fixed to a front portion of an automated vehicle, and each rear image received from a rear camera fixed to a rear portion of the automated vehicle;
determining, by the processor, one or more front image features from the front overlay image, and one or more rear image features from the rear overlay image;
determining, by the processor, one or more differential image features based upon comparing the one or more front image features against the one or more rear image features from the rear image; and
identifying, by the processor, a fluid leak of the automated vehicle using the one or more differential image features by applying an object recognition engine on the one or more differential image features.

7. The method according to claim 6, further comprising, for each front image, generating, by the processor, a first metadata stamp for the front image and a corresponding second metadata stamp for a particular rear image of the plurality of rear images.

8. The method according to claim 7, wherein the second metadata stamp of each rear image of the plurality of rear images corresponds to the first metadata stamp of at least one front image of the plurality of front images.

9. The method according to claim 7, wherein the first metadata stamp and the second metadata stamp includes at least one of a timestamp or a location stamp.

10. The method according to claim 6, further comprising generating, by the processor, a notification indicating the fluid leak in response to identifying the fluid leak.

11. A system comprising:
a non-transitory computer-readable medium comprising instructions that when executed by at least one processor are configured to:
receive a front image from a front camera of an automated vehicle and a rear image from a rear camera of the automated vehicle, the front camera is situated at a front portion of the automated vehicle and directed towards a road surface beneath the front portion of the automated vehicle, and the rear camera is situated at a rear portion of the automated vehicle and directed towards the road surface beneath the rear portion of the automated vehicle;
determine one or more front image features from the front image, and one or more rear image features from the rear image;
determine one or more differential image features based upon comparing the one or more front image features against the one or more rear image features from the rear image; and
identify a fluid leak of the automated vehicle using the one or more differential image features by applying an object recognition engine on the one or more differential image features.

12. The system according to claim 11, wherein the at least one processor is further configured to:
generate a first metadata stamp for the front image and a corresponding second metadata stamp for the rear image; and
store, into an image log, the front image, the first metadata stamp, second metadata stamp, and the rear image.

13. The system according to claim 12, wherein the at least one processor is further configured to select the rear image having the second metadata stamp according to the corresponding first metadata stamp of the front image associated with the rear image.

14. The system according to claim 12, wherein the first metadata stamp and the second metadata stamp includes at least one of a timestamp or a location stamp.

15. The system according to claim 11, wherein the at least one processor is further configured to generate a notification indicating the fluid leak in response to identifying the fluid leak.
